(19) United States
(12) Patent Application Publication
(10) Pub. No.: US 2024/0020848 A1
(43) Pub. Date: Jan. 18, 2024

(54) ONLINE TEST TIME ADAPTIVE SEMANTIC SEGMENTATION WITH AUGMENTATION CONSISTENCY

(71) Applicant: QUALCOMM Incorporated, San Diego, CA (US)

(72) Inventors: Debasmit DAS, San Diego, CA (US); Shubhankar Mangesh BORSE, San Diego, CA (US); Hyojin PARK, San Diego, CA (US); Kambiz AZARIAN YAZDI, San Diego, CA (US); Hong CAI, San Diego, CA (US); Risheek GARREPALLI, San Diego, CA (US); Fatih Murat PORIKLI, San Diego, CA (US)

(21) Appl. No.: 18/349,771

(22) Filed: Jul. 10, 2023

Related U.S. Application Data
(60) Provisional application No. 63/388,643, filed on Jul. 13, 2022.

(51) Int. Cl. G06T 7/168

(52) U.S. Cl. CPC G06T 7/168; G06T 2207/20132

(57) ABSTRACT

Systems and techniques are provided for processing one or more images. For instance, according to some aspects of the disclosure, a method may include obtaining an unlabeled image and generating at least one transformed image based on the unlabeled image. The method may include processing the unlabeled image using a pre-trained semantic segmentation model to generate a first segmentation output. The method may further include processing the at least one transformed image using the pre-trained semantic segmentation model to generate at least a second segmentation output. The method may include fine-tuning, based on the first segmentation output and at least the second segmentation output, one or more parameters of the pre-trained semantic segmentation model.

### PRIORITY CLAIM

This application claims the benefit of U.S. Provisional Application No. 63/388,643, filed on Jul. 13, 2022, which is hereby incorporated by reference, in its entirety and for all purposes.

### FIELD

The present disclosure generally relates to image processing. For example, aspects of the present disclosure are related to systems and techniques for performing image processing using one or more machine learning systems in which the network enforces consistency across one or more transformations of an unlabeled image such as a geometric transformation and a photometric transformation.

### BACKGROUND

The increasing versatility of digital camera products has allowed digital cameras to be integrated into a wide array of devices and has expanded their use to different applications. For example, phones, drones, cars, computers, televisions, and many other devices today are often equipped with camera devices. The camera devices allow users to capture images and/or video from any system. The images and/or videos can be captured for recreational use, professional photography, surveillance, and automation, among other applications. Moreover, camera devices are increasingly equipped with specific functionalities for modifying images or creating artistic effects on the images. For example, many camera devices are equipped with image processing capabilities for generating different effects on captured images.

Many image processing techniques rely on image segmentation algorithms that divide an image into segments which can be analyzed or processed to identify objects, produce specific image effects, etc. Some example practical applications of image segmentation include chroma key compositing, feature extraction, object detection, recognition tasks (e.g., object recognition, face recognition, etc.), image stylization, machine vision, medical imaging, and depth-of-field (or “bokeh”) effects, among others. However, camera devices and image segmentation techniques often yield poor and inconsistent results.

Some systems utilize machine learning to perform semantic segmentation on images. Such systems can be referred to as adaptive semantic segmentation systems. Many adaptive semantic segmentation systems operate using batches of unlabeled target domain data as input. Such semantic segmentation systems cannot handle online streaming data. Existing adaptive semantic segmentation systems also typically use pseudo-labels for supervision. However, pseudo-labels can be inherently noisy and can sometimes provide incorrect supervision for training purposes (e.g., supervised learning or training).

### SUMMARY

In some examples, systems and techniques are described for performing image processing using one or more machine learning architectures. For example, a processor-implemented method for processing one or more images is provided that includes obtaining an unlabeled image; generating at least one transformed image based on the unlabeled image; processing the unlabeled image using a pre-trained semantic segmentation model to generate a first segmentation output; processing the at least one transformed image using the pre-trained semantic segmentation model to generate at least a second segmentation output; and based on the first segmentation output and at least the second segmentation output, fine-tuning one or more parameters of the pre-trained semantic segmentation model.

In some examples, an apparatus for processing data is provided. The apparatus may include at least one memory and at least one processor (e.g., implemented in circuitry) coupled to the at least one memory and configured to: obtain an unlabeled image; generate at least one transformed image based on the unlabeled image; process the unlabeled image using a pre-trained semantic segmentation model to generate a first segmentation output; process the at least one transformed image using the pre-trained semantic segmentation model to generate at least a second segmentation output; and based on the first segmentation output and at least the second segmentation output, fine-tune one or more parameters of the pre-trained semantic segmentation model.

In some examples, a non-transitory computer-readable medium is provided that has stored thereon instructions that, when executed by one or more processors, cause the one or more processors to: obtain an unlabeled image; generate at least one transformed image based on the unlabeled image; process the unlabeled image using a pre-trained semantic segmentation model to generate a first segmentation output; process the at least one transformed image using the pre-trained semantic segmentation model to generate at least a second segmentation output; and based on the first segmentation output and at least the second segmentation output, fine-tune one or more parameters of the pre-trained semantic segmentation model.

In some examples, an apparatus for processing one or more images is provided. The apparatus may include means for obtaining an unlabeled image; means for generating at least one transformed image based on the unlabeled image; means for processing the unlabeled image using a pre-trained semantic segmentation model to generate a first segmentation output; means for processing the at least one transformed image using the pre-trained semantic segmentation model to generate at least a second segmentation output; and means for fine-tuning, based on the first segmentation output and at least the second segmentation output, one or more parameters of the pre-trained semantic segmentation model.

In some aspects, one or more of the apparatuses described herein is, can be part of, or can include a mobile device or wireless communication device (e.g., a mobile telephone or so-called “smart phone” or other mobile device), an extended reality (XR) device (e.g., a virtual reality (VR) device, an augmented reality (AR) device, or a mixed reality (MR) device), a vehicle or computing system, device, or component of a vehicle, a wearable device (e.g., a network-connected watch or other wearable device), a personal computer, a laptop computer, a tablet computer, a server computer, a robotics device or system, an aviation system, or other system or device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1A illustrates an example implementation of a system-on-a-chip (SoC), in accordance with some examples;

FIG. 1B illustrates an example framework for obtaining a pre-trained image semantic segmentation model and then using the model during testing time, in accordance with some examples;

FIG. 2 illustrates an example framework for obtaining a pre-trained image semantic segmentation model and then using the model during testing time to maintain consistency across a geometric transformation and a photometric transformation of an unlabeled image, in accordance with some examples;

FIG. 3 illustrates an example of various approaches to applying loss between different types of data which can be used to maintain consistency, in accordance with some examples;

FIG. 4 is a flow diagram illustrating an example of a process for adapting a pre-trained image semantic segmentation model by enforcing consistency across one or more variations of unlabeled data, in accordance with some examples; and

FIG. 5 is a block diagram illustrating an example of a computing system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The demand and consumption of image and video data has significantly increased in consumer and professional settings. Many devices and systems are equipped with capabilities for capturing and processing image and video data. For example, a camera or a computing device including a camera (e.g., a mobile telephone or smartphone including one or more cameras) can capture a video and/or image of a scene, a person, an object, etc. The image and/or video can be captured and processed and output (and/or stored) for consumption. The image and/or video can be further processed for certain effects, such as, without limitation, compression, frame rate up-conversion, sharpening, color space conversion, image enhancement, high dynamic range (HDR), de-noising, low-light compensation, among others. The image and/or video can also be further processed for certain applications such as computer vision, extended reality (e.g., augmented reality, virtual reality, and the like), image recognition (e.g., face recognition, object recognition, scene recognition, etc.), and autonomous driving, among others. In some examples, the image and/or video can be processed using one or more image or video artificial intelligence (AI) models, which can include, but are not limited to, AI quality enhancement and AI augmentation models.

Image and video processing operations can be computationally intensive. In some cases, image and video processing operations can become increasingly computationally intensive as the resolution of the input image or frame of video data increases (e.g., as the number of pixels to be processed per input image or frame of video data increases). For example, a frame of video data with a 4K resolution can include approximately four times as many individual pixels as a frame of video data with a full HD (e.g., 1080p) resolution. In some examples, image and video processing operations can be performed by processing each pixel individually. In some examples, image and video processing operations can be performed using one or more machine learning models to derive a mapping from input image data (e.g., raw image data captured by one or more image sensors) to a final output image.

For example, one or more machine learning models (e.g., dep learning systems) can be used to derive a mapping between raw image data that includes a color value for each pixel location and a final output image. The final output image can include processed image data derived from the raw image data (e.g., based on the mapping learned by the one or more machine learning models). In some examples, the one or more machine learning models can include a neural network of convolutional filters (e.g., a convolutional neural network (CNN)) for the image and/or video processing task. For instance, an image processing neural network can include an input layer, multiple hidden layers, and an output layer. The input layer can include the raw image data from one or more image sensors. The hidden layers can include convolutional filters that can be applied to the input data, or to the outputs from previous hidden layers to generate feature maps. The filters of the hidden layers can include weights used to indicate an importance of the nodes of the filters. In some cases, the neural network can have a series of many hidden layers, with early layers determining simple and low-level characteristics of the raw image input data, and later layers building up a hierarchy of more complex and abstract characteristics. The neural network can then generate the final output image (e.g., making up the output layer) based on the determined high-level features.

Deep learning systems may produce state-of-the-art results when tested on data with similar distribution to training data that is used to train the deep learning systems. However, whenever there is large distribution shift between training and testing data, performance of deep learning systems may begin to degrade. For example, such a phenomenon is apparent when deep learning systems are deployed off-the-shelf on real-world environments, such as autonomous vehicles trained to operate in one city but then is moved to a new city or extended reality (XR) devices (e.g., a virtual reality (VR) device, an augmented reality (AR) device, or a mixed reality (MR) device) trained on one home that is then moved to a new home.

Various devices (e.g., autonomous vehicles, XR devices, etc.) may perform the task of semantic segmentation to classify pixels of images into different classes (e.g., a person, a sky, a building, a street, etc.). Semantic segmentation may perform dense prediction or labeling of pixels for better scene understanding. Because semantic segmentation can be a dense prediction task, labelling datasets for training and/or testing can be a laborious task. In some cases, semantic segmentation models can be pre-trained on synthetic datasets, where labels can be obtained (e.g., from game engines). Once the models are pre-trained on the synthetic datasets, the models can be deployed in real-world target environments provided the distribution shift is accounted for by using domain adaptation methods. These domain adaptation methods may assume the presence of a large number of unlabeled images from the target environment. As a result, the pre-trained semantic segmentation model may be fine-tuned on the large batches of unlabeled target domain images and also on the labeled source domain images, if present, for multiple iterations to produce a domain-invariant model. Such domain-invariant segmentation models may produce much better pixel accuracy compared to models without any adaptation on the unlabeled target domain data.

Although the above-described domain adaptation methods may provide a boost in image segmentation performance, the performance of such methods may be an overestimate with respect to more practical real-world adaptation scenarios. For instance, in current domain adaptive segmentation methods, there may be a held-out unlabeled target domain split for offline adaptation and a separate split for testing. In realistic situations, there may not be access to a large number of unlabeled images before evaluation can begin. For example, an XR device, a personal robot, or other device or system that attempts to segment a scene when deployed in a new environment gets exposed instantly to an online unsupervised stream of images. The semantic segmentation model deployed by such devices needs to adapt to the scene depicted in the online stream of images and also needs to provide accurate predictions on the online stream of images.

Current domain adaptation methods may not be directly applicable to an arrangement of online model adaptation on single test images at a time. For instance, forward and backward passes of a single image through a pre-trained segmentation model might produce noisy losses and gradients and consequently unreliable predictions. Further, as noted previously, adaptive semantic segmentation systems typically operate (e.g., are trained to operate) using batches of unlabeled target domain data as input and cannot handle online streaming data. For example, test-time adaptive (TTA) semantic segmentation considers adaptation of a source pre-trained image semantic segmentation model on unlabeled test images from a new target distribution. However, most TTA methods for semantic segmentation consider adapting on batches of target data distribution, which is contrary to real-world situations, where samples from a novel environment arrive one-by-one in an online fashion. Furthermore, adaptive semantic segmentation systems typically use pseudo-labels for supervision. For instance, a machine learning system (e.g., a neural network) may process a batch of unlabeled images and output one or more segmentation masks for the batch of unlabeled images. Pseudo labels can be generated based on the one or more segmentation masks, which can be used to further train the machine learning system. However, pseudo-labels can be inherently noisy and thus can provide incorrect supervision for training the machine learning system (e.g., when performing supervised learning or training).

To address such issues, systems, apparatuses, methods (also referred to as processes), and computer-readable media (collectively referred to herein as “systems and techniques”) are described herein that can adapt a pre-trained image semantic segmentation model (e.g., one or more neural networks) to an online stream of unlabeled test images and produce semantic segmentation predictions (e.g., segmentation masks) using the adapted image semantic segmentation model. The systems and techniques may use augmentation consistency as an unsupervised loss for adaptation the model. Such an approach enables the adaptation of a pre-trained image semantic segmentation model in an on-line test time mode in which an unlabeled image or other data is augmented in one or more different ways (e.g., by performing one or more geometric transformations and/or one or more photometric transformations) to generate one or more augmented images (or other data). The unlabeled image and the one or more augmented images (or other data) can then be processed by the pre-trained image semantic segmentation model to generate predictions that can then be used to further train (and thus adapt) the pre-trained image semantic segmentation model to yield a trained or adapted image semantic segmentation model. Adapting or training the semantic segmentation model using such an approach allows the semantic segmentation model to be adaptable to variations in input data (e.g., invariant to photometric transformations, equivariant to geometric transformations, etc.), resulting in consistency in the outputs generated by semantic segmentation model.

Such systems and techniques can adapt a semantic segmentation model without requiring the construction of pseudo-labels for training the model, which may be noisy for domain-shifted new images. The augmentation consistency also enforces the model to be invariant and/or equivariant to different kinds of augmentations (e.g., geometric transformations and/or photometric transformations) which may be considered as different domains by themselves. Furthermore, in some cases, machine learning models are trained on a powerful computing system and then deployed on one or more destination devices, such as vehicles, mobile devices, extended reality (XR) systems, etc. However, such destination devices may not have sufficient computing power to further train or adapt the model. The systems and techniques described herein fine-tune a semantic segmentation model to a particular context without the need for a large amount of computing power to continue to train the model in the same manner that the model was pre-trained. Because a pre-trained model needs to adapt to single images at a time, pseudo-labels can be inherently noisy and hence the systems and techniques described herein propose using augmentation consistency to update model parameters. For instance, the segmentation network may be enforced to be invariant to photometric input transformations as well as be equivariant to geometric input transformations.

Various aspects of the present disclosure will be described with respect to the figures.

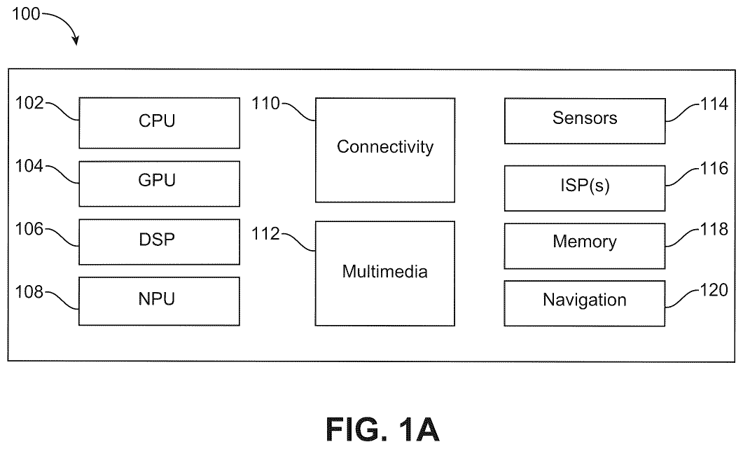

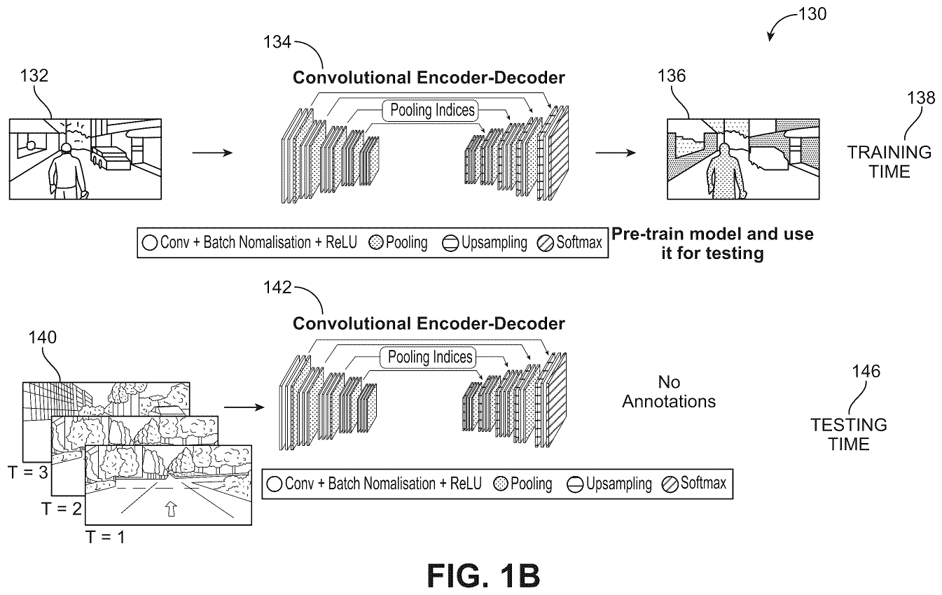

FIG. 1A illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system. In some examples, the sensor processor 114 can be associated with or connected to one or more sensors for providing sensor input(s) to sensor processor 114. For example, the one or more sensors and the sensor processor 114 can be provided in, coupled to, or otherwise associated with a same computing device.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected. SOC 100 and/or components thereof may be configured to perform image processing using machine learning techniques according to aspects of the present disclosure discussed herein. For example, SOC 100 and/or components thereof may be configured to perform semantic image segmentation and/or object detection according to aspects of the present disclosure.

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding the output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In some examples, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

FIG. 1B is a diagram illustrating an example framework 130 including an initial set of training data 132 that is used to train (during a training time 138) a convolutional encoder-decoder 134 to perform semantic segmentation. For example, once trained, the convolutional encoder-decoder 134 can produce an output classification or output data 136. As shown, the output classification or output data 136 can include a segmentation map. Note that the segmentation map differentiates different objects or regions of the image such as the person, the sky, the vehicle, the road, buildings and so forth. The convolutional encoder-decoder 134 can be pre-trained and then used for testing. At a later point in time (after the convolutional encoder-decoder 134 is trained to perform semantic segmentation), a series of images 140 (e.g., received at times T=1, T=2, and T=3) with no annotations or labels may be received at different times by the pre-trained image semantic segmentation model 142 during a testing time 146. The pre-trained image semantic segmentation model 142 can be adapted or further trained using the series of images 140.

As noted above, systems and techniques are described herein that can enable adaptation of a pre-trained image semantic segmentation model (e.g., the pre-trained image semantic segmentation model 142 after the initial training at training time 138) without the use of labels or annotations in the further training data (e.g., the series of images 140). For instance, as described in more detail herein, the systems and techniques can augment one or more unlabeled images (e.g., by performing one or more geometric transformations and/or one or more photometric transformations) to generate one or more augmented images. Using the one or more unlabeled images and the one or more augmented images, the pre-trained image semantic segmentation model 142 can generate predictions. Features (e.g., logits, predictions, etc.) from the pre-trained image semantic segmentation model 142 can then be used to further train (and thus adapt) the pre-trained image semantic segmentation model 142 to yield or generate a trained or adapted image semantic segmentation model. Such systems and techniques enforce consistency across at least one variation of unlabeled data applied to a pre-trained semantic segmentation model. For example, such an approach trains the pre-trained image semantic segmentation model 142 to be invariant to photometric transformations and equivariant to geometric transformations, which leads to consistency in the outputs generated by the pre-trained image semantic segmentation model 142.

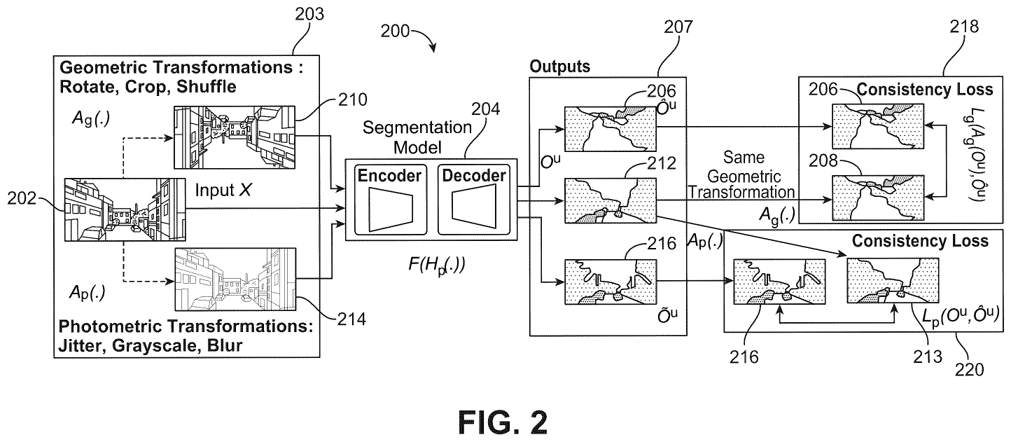

FIG. 2 is a diagram illustrating an example of a system 200 including a pre-trained image semantic segmentation model 204, which can include a convolutional encoder-decoder. As shown, an unlabeled image 202 (which can be also any type of unlabeled data and not just image data) is obtained (e.g., received or retrieved). The system 200 generates one or more variations or transformations of the unlabeled image 202. For instance, the system 200 can apply one or more geometric transformations, one or more photometric transformations, and/or other types of transformations.

According to some aspects, the system 200 can perform a geometric transformation on the unlabeled image 202 to generate one or more geometrically transformed images (e.g., a geometrically transformed image 210). Examples of geometric transformations that can be performed by the system 200 can include one or more of a rotation, a crop, a pixel shuffle (e.g., to shuffle the pixels from an original location in the unlabeled image 202 to a new location), cutting up of the image into puzzle pieces, moving the puzzle pieces around, any combination thereof, and/or other geometric transformations. In the example of FIG. 2, the geometric transformation applied to the unlabeled image 202 to generate the geometrically transformed image 210 is a rotation of 180°.

The system 200 may also perform a photometric transformation on the unlabeled image 202 to generate one or more photometrically transformed images (e.g., a photometrically transformed image 214). Examples of photometric transformations that can be performed by the system 200 can include on or more of a grayscale change, a color jitter operation, a blurring of the image, any combination thereof, and/or other photometric transformations. Transformations other than geometric and/or photometric transformations or combinations of transformations can be performed by the system 200 as well.

The pre-trained image semantic segmentation model 204 may process the unlabeled image 202, the geometrically transformed image 210, and the photometrically transformed image 214 to generate respective semantic segmentation outputs. For example, the pre-trained image semantic segmentation model 204 can generate a first output 212 based on processing of the unlabeled image 202. The pre-trained image semantic segmentation model 204 can generate a second output 206 based on processing of the geometrically transformed image 210. The pre-trained image semantic segmentation model 204 can generate a third output 216 based on processing of the photometrically transformed image 214.

As noted above, the systems and techniques can be used to enforce output consistency in one or more configurations, such as consistency between the first output 212 and the second output 206 and/or the first output 212 and the third output 216. For instance, the system 200 can apply the same geometric transformation to the first output 212 that was applied to the unlabeled image 202 (when generating the geometrically transformed image 210) to generate a geometrically transformed output 208. The system 200 can compute or determine a consistency loss (e.g., as shown in box 218) between features associated with the geometrically transformed output 208 and features associated with the second output 206, which can apply or enforce consistency across the second output 206 and the geometrically transformed output 208. The system 200 can also apply the same photometric transformation to the first output 212 that was applied to the unlabeled image 202 (when generating the photometrically transformed image 214) to generate a photometrically transformed output 213. A consistency loss (e.g., as shown in box 220) can be computed between features associated with the photometrically transformed output 213 and features associated with the third output 216, which can apply or enforce consistency across the third output 216 and the photometrically transformed output 213.

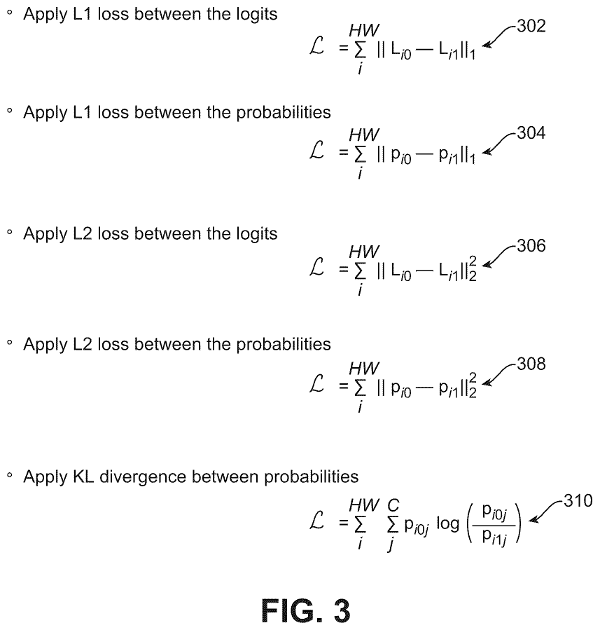

As discussed previously, the process of applying or enforcing consistency across the augmented data is to determine consistency losses between the original output data (e.g., the first output 212) and the output of the augmented data (e.g., the second output 206 or the third output 216). There can be different types of losses with different distance formulations. FIG. 3 illustrates the application of different types of losses. In some examples, an L1 loss 302 and/or an L2 loss 306 can be determined between logits of the pre-trained image semantic segmentation model 204. A logit refers to features (e.g., from one or more feature maps) output by one or more layers of the pre-trained image semantic segmentation model 204 prior to a normalization layer (e.g., the features that will be input to the Softmax layer, such as the Softmax layer shown in FIG. 1B). Those of skill in the art will understand the use of logits in machine learning and data transformations.

In some examples, the L1 loss 302 can be determined between logits of the pre-trained image semantic segmentation model 204 (shows as logits Lᵢ₀, including a logit for each pixel i) after generating the geometrically transformed output 208 and/or the photometrically transformed output 213 based on the original unlabeled image 202 and the logits of the pre-trained image semantic segmentation model 204 (shown as logits Lᵢ₁, including a logit for each pixel i) after generating one or both of the second output 206 and/or the third output 216 based on the transformed or augmented images (e.g., the geometrically transformed image 210 and/or photometrically transformed image 214).

In some cases, the L2 loss 306 can be determined between the logits Lᵢ₀ of the pre-trained image semantic segmentation model 204 after generating the geometrically transformed output 208 and/or the photometrically transformed output 213 and the logits Lᵢ₁ of the pre-trained image semantic segmentation model 204 after generating one or both of the second output 206 and/or the third output 216. In some examples of the geometric consistency loss, the system 200 can obtain an input image and can rotate the input image to generate a rotated input image. The system 200 can determine logits of the input image (e.g., logits of the model feature outputs when processing the input image) and logits of the rotated input image (e.g., logits of the model feature outputs when processing the rotated input image) and can rotate the logits of input image in the same way that the input image was rotated to generate the rotated input image. The system 200 can then apply an L1 loss, L2 loss, and/or other loss function on the rotated logits and the logits of the rotated image.

In some cases, an L1 loss 304 and/or an L2 loss 308 can be determined between the probabilities output by the pre-trained image semantic segmentation model 204 (e.g., the output of a normalization layer, such as the output of the Softmax layer shown in FIG. 1B). For example, the L2 loss 308 can be determined between a probability vector (denoted as Pᵢ₀ in FIG. 3) defining the geometrically transformed output 208 and/or the photometrically transformed output 213 generated based on the original unlabeled image 202 and a probability vector (denoted as Pᵢ₁ in FIG. 3) defining the second output 206 and/or the third output 216 generated based on the transformed or augmented images (e.g., the geometrically transformed image 210 and/or photometrically transformed image 214). In some examples, the L2 loss 308 can be determined between the probability vector Pᵢ₀ defining the geometrically transformed output 208 and/or the photometrically transformed output 213 and the probability vector P 11 defining the second output 206 and/or the third output 216.

In some aspects, a Kullback-Leibler (KL) divergence loss 310 between probabilities output by the pre-trained image semantic segmentation model 204 can be determined. For example, a probability vector Pᵢ₀ⱼ (of pixel i and class j) defining the geometrically transformed output 208 and/or the photometrically transformed output 213 generated based on the original unlabeled image 202 is used along with a probability vector Pᵢ₁ⱼ (of pixel i and class j) defining the second output 206 and/or the third output 216 generated based on the transformed or augmented images (e.g., the geometrically transformed image 210 and/or photometrically transformed image 214). Examples of the various losses are shown in FIG. 2 in boxes 218 and 220 (corresponding to consistency losses) of FIG. 2.

Upon determining one or more of the losses described with respect to FIG. 3 and/or other losses, a backpropagation technique can be performed to fine-tune parameters (e.g., weights, biases, etc.) of the pre-trained image semantic segmentation model 204. The process of obtaining unlabeled images, generating augmentations or transformations of the unlabeled images, determining losses based on the unlabeled and augmented/transformed images, and performing backpropagation to fine-tune the pre-trained image semantic segmentation model 204 can be performed for a number of iterations until the pre-trained image semantic segmentation model 204 is fine-tuned to a certain accuracy or consistency (e.g., until the pre-trained image semantic segmentation model 204 is invariant to photometric transformations and/or equivariant to geometric transformations).

As described above, for adaptation on an unlabeled sequence of images, the systems and techniques described herein can optimize augmentation consistency loss using one or more types of augmentations, such photometric and geometric augmentations or transformations. As noted herein, photometric transformations may include grayscale conversion, color jitter, gaussian blur, any combination thereof, and/or other photometric transformations. Geometric transformations may include rotation of an image, cropping of an image, a shuffling of pixels of an image, any combination thereof, and/or other geometric transformations. When the types of transformations are applied to an input image, a semantic segmentation model should produce a segmentation map that is the same as (and not different from) a segmentation map that would be produced when no transformation is applied on the input image (a property referred to as invariance with respect to photometric transformations and equivariance with respect to geometric transformations). However, neural networks are highly sensitive to changes in input and can produce different segmentation maps when presented with a photometric transformation and/or geometric transformation, and hence are not naturally invariant to photometric transformations or equivariant to geometric transformations. The systems and techniques described herein minimize the output prediction differences between an original input and any photometric or geometric transformations.

In some examples and as shown in FIG. 2, a test image denoted x and a sampled photometric augmentation Aₚ (·) are obtained. When the photometric augmentation is applied on the test image x, a system (e.g., the system 200) can produce an augmentation \tilde{x}=Aₚ (x). For both the original input image x and its augmentation \tilde{x}, the system can produce unsupervised output logits o^{u}=Hₚ (F(x)) and õ^{u}=Hₚ (F(\tilde{x}) respectively, where Hₚ refers to as a prediction or classification head. To minimize the difference between o^{u} and õ^{u}, the system can use a discrepancy or consistency loss term Lₚ (o^{u},õ^{u}) as shown in box 220. As discussed previously, example losses or discrepancies can be L1 distance or loss, L2 distance or loss, KL divergence between the probabilities obtained from the logits, and/or other loss. As noted herein, other features can be considered by the system in determining losses, such as predictions generated by a normalization layer (e.g., a Softmax layer).

For geometric transformations, the system may consider augmentations, such as random cropping, rotations, pixel shuffling, etc., as noted above. When geometric augmentations are applied to an input image, the semantic segmentation model map should have the same transformation as that of the segmentation map of the original input image (hence equivariance). Segmentation networks are not necessarily equivariant to geometric transformations. The systems and techniques described herein operate to enforce such equivariance, such as by minimizing the difference in output predictions for the transformed segmentation map of the input image and the segmentation map of the transformed image.

In some examples and shown in FIG. 2, a test image x and a sampled geometric augmentation A_{g} (·) are obtained. When the geometric augmentation is applied on the test image x, the system may produce an augmented image \hat{x}=A_{g}(x). For both the original input image x and its augmentation \hat{x}, the system can generate unsupervised output logits o^{u}=Hₚ(F(x)) and ôu=Hₚ(F(\hat{x})) respectively. To enforce equivariance, the system may minimize the difference between ô^{u} and the transformed logits A_{g}(o^{u}) by using a discrepancy or consistency loss term L_{g}(A_{g}(o^{u}),ô^{u}) as shown in box 218. The discrepancy may be the same or may be different as that used for photometric augmentation consistency loss (e.g., L1 difference or loss, L2 difference or loss, KL divergence, etc.).

In some aspects, for adapting the semantic segmentation model on the test sample x, a combination of photometric augmentation consistency loss and geometric augmentation consistency loss may be used as follows:

L_{TT A}(x)=Lₚ(o^{u},o^{˜u})+L_{g}(A_{g}(o^{u}),ô^{u}) (1)

In some examples, after adaptation (e.g., once the model is updated using L_{TT A}(x)), the output logits of the test sample (e.g., a test image) can be used for performing inference using the semantic segmentation model

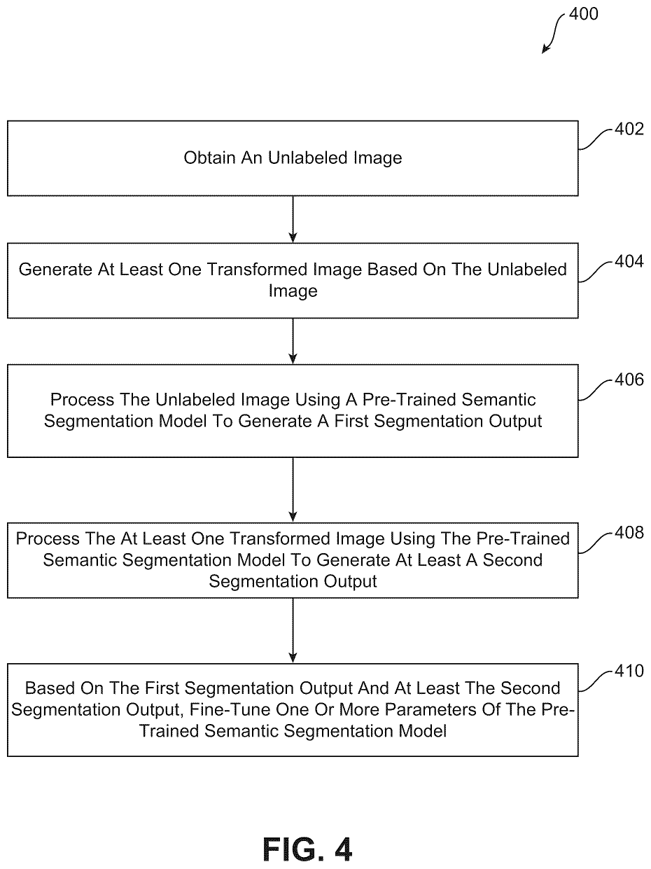

FIG. 4 illustrates an example method or process 400 which can be used to adapt or train (e.g., fine-tune) a pre-trained model to enforce of apply consistency across at least one augmentation of unlabeled data. At block 402, the process 400 may include obtaining (e.g., receiving) an unlabeled image. The unlabeled image may not include a label or a pseudo-label, as described previously. In some cases, the process 400 may include receiving a plurality of images (e.g., sequentially receive the plurality of images of a stream of video). In some aspects, the plurality of images may also not be a chronological succession of images either but may be a set of images independent of a stream of video.

At block 404, the process 400 may include generating at least one transformed image based on the unlabeled image. In some cases, the process 400 may generate the at least one transformed image by applying one or more photometric transformations to the unlabeled image. In some examples, the one or more photometric transformations may include a grayscale adjustment, a color adjustment, a color jitter, a blur effect, any combination thereof, and/or other photometric transformations. In some cases, the process 400 may generate the at least one transformed image by applying one or more geometric transformations to the unlabeled image. In some examples, the one or more geometric transformations may include a rotation, a crop, a shuffling of pixels, any combination thereof, and/or other geometric transformations.

At block 406, the process 400 may include processing the unlabeled image using a pre-trained semantic segmentation model (e.g., the pre-trained image semantic segmentation model 204 shown in FIG. 2) to generate a first segmentation output (e.g., the first output 212 of FIG. 2).

At block 408, the process 400 may include processing the at least one transformed image using the pre-trained semantic segmentation model to generate at least a second segmentation output (e.g., the second output 206 and/or the third output 216 of FIG. 2).

At block 410, the process 400 may include fine-tuning, based on the first segmentation output and at least the second segmentation output, one or more parameters of the pre-trained semantic segmentation model. In some aspects, as described previously, fine-tuning of the one or more parameters of the pre-trained semantic segmentation model enforces the pre-trained semantic segmentation model to be at least one of invariant to photometric transformations or equivariant to geometric transformations. In some aspects, the process 400 may include generating a trained model based on fine-tuning of the one or more parameters of the pre-trained image semantic segmentation model 204.

In some aspects, the process 400 may include determining at least one loss (e.g., one or more of the loss functions shown in FIG. 3 and/or one or more of the consistency loss values shown in boxes 218, 220 of FIG. 2) between features of the pre-trained image semantic segmentation model 204 based on the generation of the first segmentation output and features of the pre-trained semantic segmentation model based on the generation of at least the second segmentation output. In such aspects, the one or more parameters of the pre-trained semantic segmentation model may be fine-tuned based on the at least one loss. In some cases, the features include probability values output by the pre-trained semantic segmentation model (e.g., output by a Softmax layer of the pre-trained semantic segmentation model, such as the Softmax layer shown in FIG. 1B). In some cases, the features include logits output by the pre-trained semantic segmentation model (e.g., the features that will be input to a Softmax layer of the pre-trained semantic segmentation model, such as the Softmax layer shown in FIG. 1B). In some cases, the at least one loss may include one or more of an L1 loss, an L2 loss, a KL divergence, any combination thereof, and/or other loss function.

In some aspects, the process 400 can provide an on-line test time adaptive approach to training the pre-trained image semantic segmentation model. In some aspects, the enforcing of the pre-trained image semantic segmentation model to apply consistency across one or more variations of the unlabeled image relative to the unlabeled image generates an output that is used to adapt the pre-trained image semantic segmentation model during an on-line test time to yield a trained image semantic segmentation model.

Other benefits of the disclosed approach include a module or model that can be used with any pre-trained segmentation network and backbone, which allows the model to evolve with the state of the art. The model can handle an online stream of data from a novel environment instead of requiring batches of data. The model does not require construction of pseudo-labels for training the network or the model.

As described herein, in some aspects, the systems and techniques described herein may apply augmentation which may be easy to apply on input images and is a more reliable approach to produce a training objective. The systems and techniques disclosed herein also provides flexibility to increase the number and variety of augmentations depending on compute limit to allow more training objectives. The solution can improve semantic segmentation quality for novel environments through online adaptation. The disclosed approach can improve accuracy for those classes which change characteristic across source and target datasets.

Examples of uses for the disclosed solution can include self-driving vehicles. Most of the urban segmentation models are trained on clean real datasets or simulated game datasets. The solution disclosed herein can be useful for online adaptation to real world scenes where accurate segmentation masks along with depth will allow the vehicle to take appropriate control actions, e.g., velocity control, steering, braking.

For extended reality use cases, indoor segmentation is required for use cases such as human occlusion rendering and semantic reconstruction. The indoor environment on which the segmentation models are trained on will have different characteristics than the deployed one. There might be changes in layout, brightness etc. In such situations, online adaptation is important to encounter the domain shift of pre-training dataset and test dataset.

Robotics is another area where the disclosed technology can be useful. Accurate semantic segmentation will enable a variety of capabilities in robotics, such as navigation, localization, and interaction with physical objects in the environment. To tackle domain shift characteristics between source dataset and target dataset such as changes in object characteristics, environment changes like illumination etc.

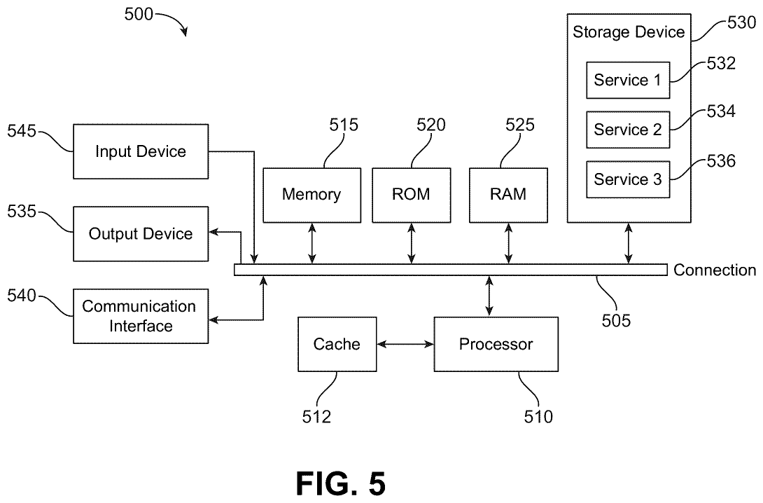

In some examples, the processes described herein (e.g., process 400 and/or any other process described herein) may be performed by a computing device, apparatus, or system. In some cases, the process 400 can be performed by a computing device or system having the computing device architecture 500 of FIG. 5. The computing device, apparatus, or system can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a laptop computer, a smart television, a camera, and/or any other computing device with the resource capabilities to perform the processes described herein, including the process 400 and/or any other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 400 is illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 400 and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 5 illustrates an example computing device architecture 500 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device architecture 500 are shown in electrical communication with each other using computing device connection 505, such as a bus. The example computing device architecture 500 includes a processing unit (CPU or processor) 510 and computing device connection 505 that couples various computing device components including computing device memory 515, such as read only memory (ROM) 520 and random-access memory (RAM) 525, to processor 510.

Computing device architecture 500 can include a cache of high-speed memory connected directly with, in close proximity to, or integrated as part of processor 510. Computing device architecture 500 can copy data from memory 515 and/or the storage device 530 to cache 512 for quick access by processor 510. In this way, the cache can provide a performance boost that avoids processor 510 delays while waiting for data. These and other engines can control or be configured to control processor 510 to perform various actions. Other computing device memory 515 may be available for use as well. Memory 515 can include multiple different types of memory with different performance characteristics. Processor 510 can include any general-purpose processor and a hardware or software service, such as service 1 532, service 2 534, and service 3 536 stored in storage device 530, configured to control processor 510 as well as a special-purpose processor where software instructions are incorporated into the processor design. Processor 510 may be a self-contained system, containing multiple cores or processors, a bus, memory controller, cache, etc. A multi-core processor may be symmetric or asymmetric.

To enable user interaction with the computing device architecture 500, input device 545 can represent any number of input mechanisms, such as a microphone for speech, a touch-sensitive screen for gesture or graphical input, keyboard, mouse, motion input, speech and so forth. Output device 535 can also be one or more of a number of output mechanisms known to those of skill in the art, such as a display, projector, television, speaker device, etc. In some instances, multimodal computing devices can enable a user to provide multiple types of input to communicate with computing device architecture 500. Communication interface 540 can generally govern and manage the user input and computing device output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof. Storage device 530 can include service 1 532, service 2 534, service 3 536 for controlling processor 510. Other hardware or software modules or engines are contemplated. Storage device 530 can be connected to the computing device connection 505. In one aspect, a hardware module that performs a particular function can include the software component stored in a computer-readable medium in connection with the necessary hardware components, such as processor 510, computing device connection 505, output device 535, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

The various illustrative logical blocks, modules, engines, circuits, and algorithm steps described in connection with the aspects disclosed herein may be implemented as electronic hardware, computer software, firmware, or combinations thereof. To clearly illustrate the interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative Aspects of the present disclosure are provided below:

Aspect 1. A processor-implemented method of processing one or more images, comprising obtaining an unlabeled image; generating at least one transformed image based on the unlabeled image; processing the unlabeled image using a pre-trained semantic segmentation model to generate a first segmentation output; processing the at least one transformed image using the pre-trained semantic segmentation model to generate at least a second segmentation output; and based on the first segmentation output and at least the second segmentation output, fine-tuning one or more parameters of the pre-trained semantic segmentation model.

Aspect 2. The processor-implemented method of Aspect 1, wherein the at least one transformed image is generated by applying one or more photometric transformations to the unlabeled image.

Aspect 3. The processor-implemented method of Aspect 2, wherein the one or more photometric transformations comprises at least one of a grayscale adjustment, a color adjustment, a color jitter, or a blur effect.

Aspect 4. The processor-implemented method of any one of Aspects 1 to 3, wherein the at least one transformed image is generated by applying one or more geometric transformations to the unlabeled image.

Aspect 5. The processor-implemented method of Aspect 4, wherein the one or more geometric transformations comprise at least one of a rotation, a crop, or a shuffling of pixels.

Aspect 6. The processor-implemented method of any one of Aspects 1 to 5, wherein fine-tuning of the one or more parameters of the pre-trained semantic segmentation model enforces the pre-trained semantic segmentation model to be at least one of invariant to photometric transformations or equivariant to geometric transformations.

Aspect 7. The processor-implemented method of any one of Aspects 1 to 6, further comprising determining at least one loss between features of the pre-trained semantic segmentation model based on generation of the first segmentation output and features of the pre-trained semantic segmentation model based on generation of at least the second segmentation output; wherein the one or more parameters of the pre-trained semantic segmentation model are fine-tuned based on the at least one loss.

Aspect 8. The processor-implemented method of Aspect 7, wherein the features include probability values output by the pre-trained semantic segmentation model.

Aspect 9. The processor-implemented method of any one of Aspects 7 or 8, wherein the features include logits output by the pre-trained semantic segmentation model.

Aspect 10. The processor-implemented method of any one of Aspects 7 to 9, wherein

the at least one loss includes at least one of an L1 loss or an L2 loss.

Aspect 11. The processor-implemented method of any one of Aspects 1 to 10, further comprising generating a trained model based on fine-tuning of the one or more parameters of the pre-trained semantic segmentation model.

Aspect 12. The processor-implemented method of any one of Aspects 1 to 11, wherein obtaining the unlabeled image comprises: receiving a plurality of images.

Aspect 13. The processor-implemented method of any one of Aspects 1 to 12, wherein the unlabeled image does not include a label or a pseudo-label.

Aspect 14. An apparatus for processing one or more images, the apparatus comprising at least one memory; and at least one processor coupled to the at least one memory and configured to: obtain an unlabeled image; generate at least one transformed image based on the unlabeled image; process the unlabeled image using a pre-trained semantic segmentation model to generate a first segmentation output; process the at least one transformed image using the pre-trained semantic segmentation model to generate at least a second segmentation output; and based on the first segmentation output and at least the second segmentation output, fine-tune one or more parameters of the pre-trained semantic segmentation model.

Aspect 15. The apparatus of Aspect 14, wherein the at least one processor is configured to generate the at least one transformed image by applying one or more photometric transformations to the unlabeled image.

Aspect 16. The apparatus of Aspect 15, wherein the one or more photometric transformations comprises at least one of a grayscale adjustment, a color adjustment, a color jitter, or a blur effect.

Aspect 17. The apparatus of any one of Aspects 14 to 16, wherein the at least one processor is configured to generate the at least one transformed image by applying one or more geometric transformations to the unlabeled image.

Aspect 18. The apparatus of Aspect 17, wherein the one or more geometric transformations comprise at least one of a rotation, a crop, or a shuffling of pixels.

Aspect 19. The apparatus of any one of Aspects 14 to 18, wherein fine-tuning of the one or more parameters of the pre-trained semantic segmentation model enforces the pre-trained semantic segmentation model to be at least one of invariant to photometric transformations or equivariant to geometric transformations.

Aspect 20. The apparatus of any one of Aspects 14 to 19, wherein the at least one processor is configured to: determine at least one loss between features of the pre-trained semantic segmentation model based on generation of the first segmentation output and features of the pre-trained semantic segmentation model based on generation of at least the second segmentation output; and fine-tune the one or more parameters of the pre-trained semantic segmentation model based on the at least one loss.

Aspect 21. The apparatus of Aspect 20, wherein the features include probability values output by the pre-trained semantic segmentation model.

Aspect 22. The apparatus of any one of Aspects 20 or 21, wherein the features include logits output by the pre-trained semantic segmentation model.

Aspect 23. The apparatus of any one of Aspects 20 to 22, wherein the at least one loss includes at least one of an L1 loss or an L2 loss.

Aspect 24. The apparatus of any one of Aspects 14 to 23, wherein the at least one processor is configured to: generate a trained model based on fine-tuning of the one or more parameters of the pre-trained semantic segmentation model.

Aspect 25. The apparatus of any one of Aspects 14 to 24, wherein, to obtain the unlabeled image, the at least one processor is configured to: receive a plurality of images.

Aspect 26. The apparatus of any one of Aspects 14 to 25, wherein the unlabeled image does not include a label or a pseudo-label.

Aspect 27. A non-transitory computer-readable medium having stored thereon instructions that, when executed by one or more processors, cause the one or more processors to perform operations according to any of Aspects 1 to 26.

Aspect 28. An apparatus comprising one or more means for performing operations according to any of Aspects 1 to 26.

What is claimed is:

1. A processor-implemented method of processing one or more images, comprising:
obtaining an unlabeled image;
generating at least one transformed image based on the unlabeled image;
processing the unlabeled image using a pre-trained semantic segmentation model to generate a first segmentation output;
processing the at least one transformed image using the pre-trained semantic segmentation model to generate at least a second segmentation output; and
based on the first segmentation output and at least the second segmentation output, fine-tuning one or more parameters of the pre-trained semantic segmentation model.

2. The processor-implemented method of claim 1, wherein the at least one transformed image is generated by applying one or more photometric transformations to the unlabeled image.

3. The processor-implemented method of claim 2, wherein the one or more photometric transformations comprises at least one of a grayscale adjustment, a color adjustment, a color jitter, or a blur effect.

4. The processor-implemented method of claim 1, wherein the at least one transformed image is generated by applying one or more geometric transformations to the unlabeled image.

5. The processor-implemented method of claim 4, wherein the one or more geometric transformations comprise at least one of a rotation, a crop, or a shuffling of pixels.

6. The processor-implemented method of claim 1, wherein fine-tuning of the one or more parameters of the pre-trained semantic segmentation model enforces the pre-trained semantic segmentation model to be at least one of invariant to photometric transformations or equivariant to geometric transformations.

7. The processor-implemented method of claim 1, further comprising:
determining at least one loss between features of the pre-trained semantic segmentation model based on generation of the first segmentation output and features of the pre-trained semantic segmentation model based on generation of at least the second segmentation output;
wherein the one or more parameters of the pre-trained semantic segmentation model are fine-tuned based on the at least one loss.

8. The processor-implemented method of claim 7, wherein the features include probability values output by the pre-trained semantic segmentation model.

9. The processor-implemented method of claim 7, wherein the features include logits output by the pre-trained semantic segmentation model.

10. The processor-implemented method of claim 7, wherein the at least one loss includes at least one of an L1 loss or an L2 loss.

11. The processor-implemented method of claim 1, further comprising:
generating a trained model based on fine-tuning of the one or more parameters of the pre-trained semantic segmentation model.

12. The processor-implemented method of claim 1, wherein obtaining the unlabeled image comprises:
receiving a plurality of images.

13. The processor-implemented method of claim 1, wherein the unlabeled image does not include a label or a pseudo-label.

14. An apparatus for processing one or more images, the apparatus comprising:
at least one memory; and
at least one processor coupled to the at least one memory and configured to:
obtain an unlabeled image;
generate at least one transformed image based on the unlabeled image;
process the unlabeled image using a pre-trained semantic segmentation model to generate a first segmentation output;
process the at least one transformed image using the pre-trained semantic segmentation model to generate at least a second segmentation output; and
based on the first segmentation output and at least the second segmentation output, fine-tune one or more parameters of the pre-trained semantic segmentation model.

15. The apparatus of claim 14, wherein the at least one processor is configured to generate the at least one transformed image by applying one or more photometric transformations to the unlabeled image.

16. The apparatus of claim 15, wherein the one or more photometric transformations comprises at least one of a grayscale adjustment, a color adjustment, a color jitter, or a blur effect.

17. The apparatus of claim 14, wherein the at least one processor is configured to generate the at least one transformed image by applying one or more geometric transformations to the unlabeled image.

18. The apparatus of claim 17, wherein the one or more geometric transformations comprise at least one of a rotation, a crop, or a shuffling of pixels.

19. The apparatus of claim 14, wherein fine-tuning of the one or more parameters of the pre-trained semantic segmentation model enforces the pre-trained semantic segmentation model to be at least one of invariant to photometric transformations or equivariant to geometric transformations.

20. The apparatus of claim 14, wherein the at least one processor is configured to:
determine at least one loss between features of the pre-trained semantic segmentation model based on generation of the first segmentation output and features of the pre-trained semantic segmentation model based on generation of at least the second segmentation output; and
fine-tune the one or more parameters of the pre-trained semantic segmentation model based on the at least one loss.

21. The apparatus of claim 20, wherein the features include probability values output by the pre-trained semantic segmentation model.

22. The apparatus of claim 20, wherein the features include logits output by the pre-trained semantic segmentation model.

23. The apparatus of claim 20, wherein the at least one loss includes at least one of an L1 loss or an L2 loss.

24. The apparatus of claim 14, wherein the at least one processor is configured to:
generate a trained model based on fine-tuning of the one or more parameters of the pre-trained semantic segmentation model.

25. The apparatus of claim 14, wherein, to obtain the unlabeled image, the at least one processor is configured to:
receive a plurality of images.

26. The apparatus of claim 14, wherein the unlabeled image does not include a label or a pseudo-label.

27. A non-transitory computer-readable medium having stored thereon instructions that, when executed by one or more processors, cause the one or more processors to:
obtain an unlabeled image;
generate at least one transformed image based on the unlabeled image;
process the unlabeled image using a pre-trained semantic segmentation model to generate a first segmentation output;
process the at least one transformed image using the pre-trained semantic segmentation model to generate at least a second segmentation output; and
based on the first segmentation output and at least the second segmentation output, fine-tune one or more parameters of the pre-trained semantic segmentation model.

28. The non-transitory computer-readable medium of claim 27, wherein the one or more processors is further configured to generate the at least one transformed image by applying one or more photometric transformations to the unlabeled image.

29. The non-transitory computer-readable medium of claim 28, wherein:
the one or more photometric transformations comprises at least one of a grayscale adjustment, a color adjustment, a color jitter, or a blur effect;
the instructions, when executed by the one or more processors, cause the one or more processors to generate the at least one transformed image by applying one or more geometric transformations to the unlabeled image; and
the one or more geometric transformations comprise at least one of a rotation, a crop, or a shuffling of pixels.

30. An apparatus comprising:
means for obtaining an unlabeled image;
means for generating at least one transformed image based on the unlabeled image;
means for processing the unlabeled image using a pre-trained semantic segmentation model to generate a first segmentation output;
means for processing the at least one transformed image using the pre-trained semantic segmentation model to generate at least a second segmentation output; and
means for, based on the first segmentation output and at least the second segmentation output, fine-tuning one or more parameters of the pre-trained semantic segmentation model.
